(19) United States
(12) Patent Application Publication
(10) Pub. No.: US 2006/0221947 A1
(43) Pub. Date: Oct. 5, 2006

(54) Multiple IP identities for end user telephony devices

(76) Inventors: Mark C. Baker, Aurora, IL (US); Gregory A. Freitag, Batavia, IL (US); Gerald W. Pfleging, Batavia, IL (US); George P. Wilkin, Bolingbrook, IL (US); David A. Zahn, Naperville, IL (US)

Correspondence Address: CARMEN B. PATTI & ASSOCIATES, LLC, ONE NORTH LASALLE STREET, 44TH FLOOR, CHICAGO, IL, 60602, US

(21) Appl. No.: 11/093,490

(22) Filed: Mar. 30, 2005

(51) Int. Cl. H04L 12/56

(52) U.S. Cl. 370/389; 370/401

(57) ABSTRACT

An apparatus in one example comprises an Internet Protocol telephone set accommodating at least first and second Internet Protocol addresses, wherein at least first and second sets of configuration parameters associated with the first and second Internet Protocol addresses are stored in the telephone set, and one of the first and second sets of configuration parameters is applied to a selected telephone line.

### BACKGROUND

This application is directed generally to communication systems and in particular to telecommunication networks that support voice and data communication, and is more particularly directed toward identity management for Internet Protocol telephony.

There are several problems with the current state of IP telephony, in that there are multiple providers that each uses their own service parameters. This causes a number of difficulties. First of all, call forwarding operations must use the TDM network and traverse network gateways to each network. In addition, multiple telephony devices (or virtual devices) are required where the end user has a business service and a personal service from different suppliers.

### SUMMARY

The invention in one implementation encompasses an apparatus. The apparatus comprises an Internet Protocol telephone set accommodating at least first and second Internet Protocol addresses, wherein at least first and second sets of configuration parameters associated with the first and second Internet Protocol/Media Access Control addresses are stored in the telephone set, and one of the first and second sets of configuration parameters is applied to a selected telephone line.

Another implementation of the invention encompasses a method. The method comprises the steps of providing an Internet Protocol telephone set accommodating at least first and second Internet Protocol/Media Access Control addresses, selecting among the at least first and second Internet Protocol addresses in response to user selection of a telephone line, and mapping a predetermined set of stored configuration parameters to the selected Internet Protocol/Media Access Control address pair.

### DESCRIPTION OF THE DRAWINGS

Features of exemplary implementations of the invention will become apparent from the description, the claims, and the accompanying drawings in which:

FIG. 1 is a representation of a portion of a typical broadband network that supports Internet voice and data services.

FIG. 2 is a more detailed view of customer premises as illustrated in FIG. 1.

FIG. 3 is a representation of tunneling in a Virtual Private Network.

### DETAILED DESCRIPTION

Although VoIP (Voice Over Internet Protocol) has been experimented with almost since the development of the Internet, and is well documented and understood, there are no known implementations of a multi set, multi personality phone that exist currently. Hardware of this nature would be a distinct advantage for manufacturers of telephone sets who wish to support multiple call appearances on a single telephone set. To reduce it to its simplest terms, existing art is really a “one phone, one gateway” or “one phone, multiple identical gateways” approach to telephony.

A provider who wishes to support an existing system using H.323 and a new system that uses SIP or other protocols (either spread over multiple gateways or on a single system) would have a distinct advantage as the market matures and the need arises to migrate users to the latest IP telephony capability. This invention allows delivery of phone services from multiple service companies simultaneously.

Basically, this development is an IP (Internet Protocol) telephone with multiple IP appearances, the ability to map entirely different settings and codec methods to each address, and assign VPN (Virtual Private Network) tunnels to each IP/Media Access Control address as needed. These settings would be adjustable by the end user. A set of parameters could be locked by an administrator who can allow optional settings to exist for additional addresses without interference with a primary line number assigned to an IP address. This locking of data may be designed to be selectable as needed by the administrator.

In an exemplary form of the invention, the phone would have two IP addresses. Of course, more than two addresses could be assigned, but two addresses are sufficient for explanatory purposes. In this exemplary embodiment, the first address may be assigned to a business line and a corresponding “line number” button on the telephone set. A set of configuration parameters is stored for this line in the firmware of the device itself. In this exemplary embodiment, a configuration file can be associated with an IP address/MAC address combination and loaded during the initialization of the device. An additional address is then made available for the end user's phone service (Vonage, for example) as line two on the telephone. Service providers like Vonage provide a temporary Directory Number which is changed for a permanent Directory Number for more lines; this process may be repeated until the resources of the IP path, or the telephone device itself, are exhausted. There is an expectation that in normal use, two to five lines may be used. The telephone device itself may also determine which gateway to use, autonomously. There may or may not be an additional “line number” assignment visible to the end user in this case.

At least a third use for a system of this general type is also contemplated. There may be different providers and more than one specific use. For example, there may be a secure gateway and a non-secure gateway. Use of these two gateways may be mutually exclusive (in other words, one cannot bridge to the other), but still allow use as a secure phone line or a public phone line via IP.

Virtual Private Network (VPN) connections should be fully supported from the telephone set to another network. The device should support both IPSec and SSL tunneling. Although this is not a requirement for system operation, embedding of VPN tunnel technology on an IP telephony device could in fact be considered for an entirely separate filing based upon the depth and complexity required to make a feature like this work.

Providing broadband access to subscribers is a critical capability for service providers. It is through broadband access that emerging multi-media applications and services can be delivered to subscribers and enable new revenue for service providers. Broadband cable network service and DSL over existing copper loops are the most common technologies to provide broadband access. Both technologies leverage the existing outside plant asset of the service provider(s). The more ambitious service providers are also deploying FTTx technologies (FTTx is Fiber-to-the-x, where “x” may be a destination such as the curb, a business, or directly to the home). However, given the current cost structure, fiber deployment to the home will be a gradual process. Cable and DSL will be the prominent broadband access technologies for some time as their infrastructures are already in place.

The initial application of broadband access is to provide subscribers with high-speed Internet access, allowing the subscriber to access web pages and download information more quickly. This service has been in place for some time. Many service providers, both cable operators as well as telephony service providers, are leveraging the existing broadband access infrastructure to deploy VoIP services as well. Many areas already have limited deployment. In deploying VoIP, a key issue is the signaling and control protocol between the equipment at the customer premise and the central office (CO) of the service provider.

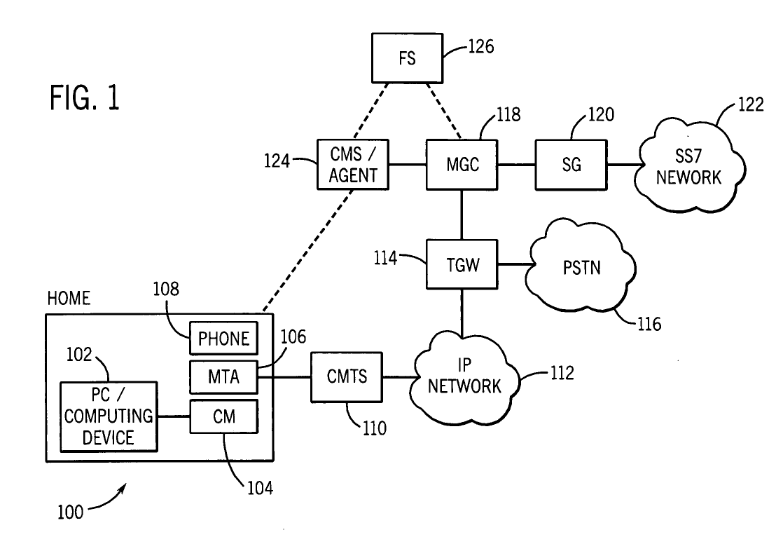

One implementation of a communication network that supports broadband IP voice and data is shown in FIG. 1. The major components necessary to support both VoIP as well as high speed Internet service are as follows:

Cable modem (CM) 104: This is the module at the customer premise 100 that translates the data signals on the cable access network into data channels (typically Ethernet) for use with customer data equipment such as a computer 102 or wireless router.

Multimedia Terminal Adapter (MTA) 106: This is the module at the customer premise 100 that supports the traditional loop start phones. It converts the analog signal from the phone 108 to IP packets. The MTA 106 can be a standalone unit or integrated in the Cable Modem 104.

The CMS/Agent 124: The call management server (CMS) 124 is the module that manages the call control of the MTAs 106. It would receive events such as on-hood and off-hook messages from the MTAs 106, and send commands such as ringing to the MTA 106.

The trunk gateway (TGW) 114: This is the module that provides bearer connectivity to the public switched telephone network (PSTN) 116.

The signaling gateway (SG) 120: This is the module that provides signaling connectivity to the public switched telephone network (PSTN) 116.

The media gateway controller (MGC) 118: This is the module that manages call control to and from the PSTN 116. It controls the trunk gateway 114 and connects to the SS7 network 122 through the signaling gateway 120.

Feature server 126: It contains the service logic for some of the enhanced services.

The protocol between the MTA 106 and the CMS 124 is commonly referred to as the network based cell signaling (NCS) protocol. It is a specific profile of the Media Gateway Control Protocol (MGCP).

Many service providers are also investigating the possibility of deploying IP based phones off the Ethernet port of the cable modem 104. As shown in FIG. 2, these phones 200 can be standalone phones or software running in an appropriately equipped PC/Computing Device 102. The phone 200 includes multiple IP/Media Access Control addresses 202, 204 that may be selected via a front panel control. Of course, a virtual phone may be implemented on a PC/Computing Device 102, and may also include multiple IP/Media Access Control addresses that may be selected through an appropriate graphical user interface. There are a number of choices for the signaling protocol for the IP based phone: H.323, Session Initiation Protocol (SIP), Media Gateway Control Protocol (MGCP), Media Gateway Control (MEGACO), etc. Most service providers consider SIP to be the dominant session control protocol in the Internet Protocol (IP) environment and would prefer the IP phones to be SIP phones. This creates a dichotomy in that the signaling protocol for the MTA is MGCP while the protocol between the SIP phones and the CMS at the CO is SIP.

The system shown in FIG. 1 is basically an overlay on top of the transport network. Therefore, may aspects of the architecture apply to other access networks such as DSL. In DSL, the DSLAM replaces the role of the Cable Modem Termination System (CMTS) 110. A DSLAM (Digital Subscriber Line Access Multiplexer) is a network device, usually at a telephone company central office, that receives signals from multiple customer Digital Subscriber Line (DSL) connections and puts the signals on a high-speed backbone line using multiplexing techniques. Depending on the product, DSLAM multiplexers connect DSL lines with some combination of asynchronous transfer mode (ATM), frame relay, or Internet Protocol networks. DSLAM enables a phone company to offer business or homes users the fastest phone line technology (DSL) with the fastest backbone network technology (ATM).

Another complication is that, for some DSL, ATM Adaptation Layer 2 (AAL 2) can be used instead of IP to convey the voice traffic. However, there are not many instances of AAL 2 implementation and for all practical purposes, packetized voice over DSL is VoIP.

The Session Initiation Protocol (SIP), based upon a standard developed by the Internet Engineering Task Force (IETF), is the session management protocol for multi-party multimedia sessions in the IP environment. It deals with the set-up, modification, and termination of the sessions. It also deals with supporting services such as establishment of a presence and locating users. SIP is part of a suite of protocols from the IETF to make the whole system work. For example, Real-Time Transport Protocol (RTP) and Real-Time Control Protocol (RTCP) deal with the encapsulation of media data, and RSVP (Resource Reservation Protocol) deals with resource reservation.

The Real-Time Transport Protocol (RTP) is an Internet protocol standard that specifies a way for programs to manage the real-time transmission of multimedia data over either unicast or multicast network services. Originally specified in Internet Engineering Task Force (IETF) Request for Comments (RFC) 1889, RTP was designed by the IETF's Audio-Video Transport Working Group to support video conferences with multiple, geographically dispersed participants. RTP is commonly used in Internet telephony applications. RTP does not in itself guarantee real-time delivery of multimedia data (since this is dependent on network characteristics); it does, however, provide the wherewithal to manage the data as it arrives to best effect.

RTP combines its data transport with a control protocol (RTCP), which makes it possible to monitor data delivery for large multicast networks. Monitoring allows the receiver to detect if there is any packet loss and to compensate for any delay jitter. Both protocols work independently of the underlying Transport layer and Network layer protocols. Information in the RTP header tells the receiver how to reconstruct the data and describes how the codec bit streams are packetized. As a rule, RTP runs on top of the User Datagram Protocol (UDP), although it can use other transport protocols. Both the Session Initiation Protocol (SIP) and H.323 use RTP.

SIP is an end-to-end protocol subscribing to a client-server architecture. The SIP end-point that initiates the session is the client, while the end-point receiving the invitation is the server. The protocol is more like HTTP (Hypertext Transfer Protocol) than conventional signaling protocols. The similarity is intentional. A major objective of the protocol is to allow services to build on top of SIP. The SIP protocol would like to tap the vast amount of experience in the industry in programming HTTP applications.

The original SIP specification is RFC 2543, with the current update being RFC 3261. The basic SIP RFC is augmented with over 40 other supporting RFCs. In addition, there are numerous IETF drafts on other aspects of SIP. This indicates wide support of this protocol in the industry. SIP employs a building block approach accommodating growth and extensions easily. However, it does raise concerns on increasing complexity, stability, performance, and interoperability. SIP requests from clients are referred to as methods. There are as number of basic methods. INVITE: initiates or changes a session. ACK: confirms a session establishment. BYE: terminates a session. CANCEL: cancels an impending invite. OPTIONS: capability inquiry. REGISTRAR: binds a permanent address to current location.

In addition to the above basic methods, there are extended methods that are optional: INFO: conveyance of information during call. COMET: condition met. PRACK: acknowledgement to provisional responses. REFER: transfer and third party call control services. NOTIFY: used to indicate transfer status. UPDATE: used to negotiate SDP parameters. Responses to the methods are numbered messages, borrowed from HTTP. They indicate success or failure of the requests, providing additional information when it is needed. As noted previously, SIP end-points can be either a user agent client or user agent server. In addition, SIP introduces three additional supporting servers.

(1) Proxy Server—a proxy server serves as a focal point where a number of users can be reached. It also relays SIP messages between end-points and other proxy servers. In some applications, it can serve as a convenient point where the logic for enhanced services could reside (or be accessed from).

(2) Redirect Server—It redirects calls to other servers.

(3) Register Server—It accepts registration requests from users and maintains user's whereabouts at the location server.

The SIP specifications provide detailed descriptions on how messages can be routed through the SIP proxy network, mechanics on how certain header fields can be modified during transit, how child SIP messages can be generated, etc. The IMS service architecture supports a wide range of services enabled by the flexibility of SIP. Given the wide acceptance of IP Multimedia Subsystem (IMS) by both wireless and wireline service providers, SIP will likely play an increasingly important role in future telecommunications networks.

A Virtual Private Network (VPN) is a fairly simple notion that allows interconnection of separate networks over a shared non-private network. Despite the simplicity of the basic concept, there are a number of types of VPNs. In one form of VPN, leased lines actually connect customer sites, but this is a costly implementation. Consequently, many customers prefer an IP infrastructure, in which data can be transferred between customer sites using the Internet.

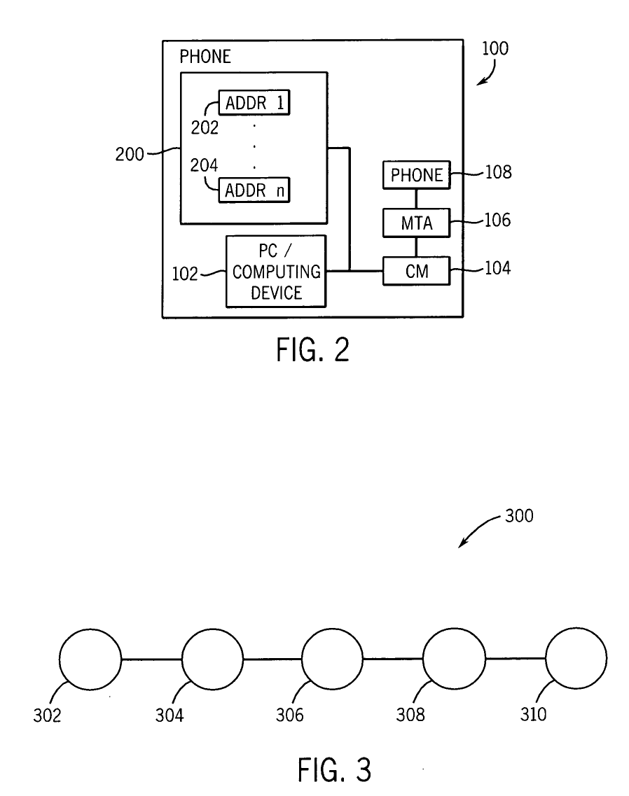

Tunneling is a technology used to route data between customer sites using the Internet. FIG. 3 illustrates how tunneling can be used between nodes. In this example, a packet of data is to be sent from an ingress node 302 to an egress node 310. The data packet is encapsulated with a header at the ingress node 302 indicating that its destination is node 310. The data packet is simply passed along from node 302, through nodes 304-308 without being decapsulated, and finally transferred to the egress node 310. In this way, none of the intervening nodes have an opportunity to examine the packet of data.

Internet Protocol security (IPsec) is a popular technology for implementation of VPN tunnels, but Secure Socket Layer (SSL) tunnels are increasingly becoming available. IPsec will continue to remain viable, particularly when access to a large variety of network resources is required.

The steps or operations described herein are just exemplary. There may be many variations to these steps or operations without departing from the spirit of the invention. For instance, the steps may be performed in a differing order, or steps may be added, deleted, or modified.

Although exemplary implementations of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

We claim:

1. An apparatus comprising:
an Internet Protocol telephone set accommodating at least first and second Internet Protocol addresses with corresponding first and second MAC addresses;
wherein at least first and second sets of configuration parameters associated with the first and second Internet Protocol addresses are stored in the telephone set, and one of the first and second sets of configuration parameters is applied to a selected telephone line.

2. The apparatus of claim 1, further comprising at least first and second telephone line selectors that select between telephone lines associated with the first and second Internet Protocol addresses with corresponding first and second MAC addresses.

3. The apparatus of claim 2, wherein the telephone line selectors comprise physical line selector buttons on the telephone set.

4. The apparatus of claim 2, wherein the telephone line selectors comprise virtual telephone line selectors included in a graphical user interface display.

5. The apparatus of claim 1, wherein the configuration parameters include a connection parameter.

6. The apparatus of claim 5, wherein the connection parameter identifies an Internet Protocol gateway.

7. The apparatus of claim 6, wherein the Internet Protocol gateway comprises a secure gateway.

8. The apparatus of claim 5, wherein the connection parameter identifies an Internet Protocol switch.

9. The apparatus of claim 5, wherein the connection parameter identifies a connection to a Virtual Private Network.

10. The apparatus of claim 9, wherein the connection to the Virtual Private Network (VPN) is established via VPN tunneling.

11. The apparatus of claim 10, wherein the connection via VPN tunneling comprises a connection via Secure Sockets Layer protocol.

12. The apparatus of claim 10, wherein the connection via VPN tunneling comprises a connection via IPSec tunneling.

13. The apparatus of claim 1, wherein the configuration parameters include an audio processing parameter.

14. The apparatus of claim 13, wherein the audio processing parameter comprises codec parameters.

15. An apparatus comprising:
an Internet Protocol telephone set accommodating at least first and second Internet Protocol addresses with corresponding first and second MAC addresses; and
at least first and second telephone line selectors manipulated by a user to select between telephone lines associated with the first and second Internet Protocol addresses; and
at least first and second sets of configuration parameters associated with the first and second Internet Protocol addresses stored in the telephone set, and one of the first and second sets of configuration parameters is applied to the telephone line selected by the user;
wherein the configuration parameters include a connection parameter and an audio processing parameter.

16. The apparatus of claim 15, wherein the telephone line selectors comprise physical line selector buttons on the telephone set.

17. The apparatus of claim 15, wherein the telephone line selectors comprise virtual telephone line selectors included in a graphical user interface display.

18. The apparatus of claim 15, wherein the connection parameter identifies an Internet Protocol gateway.

19. The apparatus of claim 18, wherein the Internet Protocol gateway comprises a secure gateway.

20. The apparatus of claim 15, wherein the connection parameter identifies an Internet Protocol switch.

21. The apparatus of claim 15, wherein the connection parameter identifies a connection to a Virtual Private Network.

22. The apparatus of claim 21, wherein the connection to the Virtual Private Network (VPN) is established via VPN tunneling.

23. The apparatus of claim 22, wherein the connection via VPN tunneling comprises a connection via Secure Sockets Layer protocol.

24. The apparatus of claim 22, wherein the connection via VPN tunneling comprises a connection via IPSec tunneling.

25. A method comprising the steps of:
providing an Internet Protocol telephone set accommodating at least first and second Internet Protocol addresses;
selecting among the at least first and second Internet Protocol addresses in response to user selection of a telephone line; and
mapping a predetermined set of stored configuration parameters to the selected Internet Protocol address.

26. The method of claim 25, wherein the step of mapping a predetermined set of stored configuration parameters to the selected Internet Protocol address further comprises the step of mapping a connection parameter to the selected Internet Protocol address.

27. The method of claim 26, wherein the connection parameter identifies an Internet Protocol gateway.

28. The method of claim 27, wherein the Internet Protocol gateway comprises a secure gateway.

29. The method of claim 26, wherein the connection parameter identifies an Internet Protocol switch.

30. The method of claim 26, wherein the connection parameter identifies a connection to a Virtual Private Network.

31. The method of claim 30, wherein the connection to the Virtual Private Network (VPN) is established via VPN tunneling.

32. The method of claim 25, wherein the step of mapping a predetermined set of stored configuration parameters to the selected Internet Protocol address further comprises the step of mapping an audio processing parameter to the selected Internet Protocol address.

33. The method of claim 32, wherein the audio processing parameter comprises codec parameters.

34. The method of claim 26, further comprising the step of autonomously mapping a connection parameter to the selected Internet Protocol address.
